(19) United States
(12) Patent Application Publication
(10) Pub. No.: US 2025/0059481 A1
(43) Pub. Date: Feb. 20, 2025

(54) MUGWORT INFUSED LIQUORS

(71) Applicant: Ali Khan, New York, NY (US)

(72) Inventor: Ali Khan, New York, NY (US)

(21) Appl. No.: 18/805,034

(22) Filed: Aug. 14, 2024

Related U.S. Application Data
(60) Provisional application No. 63/532,428, filed on Aug. 14, 2023.

(51) Int. Cl. C12G 3/055

(52) U.S. Cl. CPC C12G 3/055

(57) ABSTRACT

A method and system for making mugwort infused alcohol by providing a mugwort herb and an alcohol, and implementing infusion through a soaking technique, a steeping technique, and a mixing technique of the mugwort herb into the alcohol. The method further includes developing timelines for each of the soaking, steeping, and mixing techniques as well as testing an efficacy of the resultant admixture.

### CROSS-REFERENCE TO RELATED APPLICATION

This application claims the benefit of priority of U.S. provisional application No. 63/532,428, U.S. provisional application number filed 14-AUG-2023, the contents of which are herein incorporated by reference.

### BACKGROUND OF THE INVENTION

The present invention relates to mugwort and, more particularly, to methods and systems for making mugwort infused alcohol.

Mugwort is an herb that is native to different parts of the world. It has been used since ancient times to cure several ailments, diseases, deficiencies, etc., and is purported to have anti-cancer properties, can cure allergies, can be used as an anti-inflammatory, pain killer, etc. Mugwort is a common name for several species of aromatic flowering plants in the genus Artemisia. In Europe, mugwort most often refers to the species Artemisia vulgaris, or common mugwort. In East Asia the species Artemisia argyi is often called “Chinese mugwort” in the context of traditional Chinese medicine. Mugwort continues to be used in many cultures throughout the world as a medicinal, spiritual, and culinary ingredient since at least the Iron Age. In contemporary culture mugwort is commonly found in foods and drinks, and remains a common ingredient in Chinese, Japanese, and Korean traditional medicine, where the leaves are used directly as a food, or to obtain oil extracts, tinctures, or burned in what is called moxibustion.

Liquor is a specific form of consumable ethanol, an alcoholic drink produced by the distillation of grains, fruits, vegetables, or sugar that have already gone through alcoholic fermentation. Other terms for liquor include spirit, distilled beverage, spirituous liquor or hard liquor.

Currently the herb mugwort cannot easily be infused into liquors.

As stated above, there are no systems or methods in place to infuse the herb mugwort into liquors. There are no specific methods or processes and/or formulas to be able to successfully infuse mugwort into different types of liquor and simultaneously (and successfully) deliver all the benefits and full effects of the mugwort in the finished product. There is a big difference between simply infusing herbs and/or other substances into liquor and infusing them in a way as to be able to deliver the full effects and benefits of the herb while at the same time enhancing the effects of the alcohol.

As can be seen, there is a need for a method and system of infusion, efficacy, and enhancement with the mugwort herb and the alcohol or alcohols into which it is being infused, i.e., different types of liquor.

### SUMMARY OF THE INVENTION

The present invention embodies a process to infuse mugwort into alcohol via a step-by-step procedure involving specific formulas which are unique to each type of liquor.

The present invention is an herbal and scientific method to create specific formulas, steps, and procedures to produce mugwort infused liquors which deliver the full range of effects and health benefits of mugwort while also delivering and enhancing the full effects of the alcohol.

In one aspect of the present invention, a method of making mugwort infused alcohol include the following steps: providing a mugwort herb; providing an alcohol; experimenting with at least one infusing technique comprising a soaking technique, a steeping technique, and a mixing technique of the mugwort herb into the alcohol; developing timelines for each of the at least one infusing techniques; and testing an admixture resulting from the at least one infusing techniques for each technique's efficacy on one or more effects of the mugwort herb and the alcohol.

These and other features, aspects and advantages of the present invention will become better understood with reference to the following drawings, description and claims.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a system and method of infusing alcohol with mugwort. The process incorporates the following systemic steps
Step 1: provide mugwort herb.
Step 2: provide different types of alcohol.
Step 3: experiment with different techniques of soaking, steeping, mixing, etc. of the mugwort herb into the alcohol.
Step 4: develop timelines for infusions and detailed methods and/or steps for infusing the herb into different types of liquor.
Step 5: document and develop specific timelines, detailed methods and/or steps for infusion (if applicable) for each different type of liquor.
Step 6: test the final product to determine whether the full effects of the herb are being delivered and the effect of the alcohol is being enhanced.

The result is that mugwort is infused into the alcohol in such a way that both its full effects are delivered along with enhancing the effects of the alcohol into which it is being infused, in this case the specific alcohol being used is liquor.

In a specific embodiment, the process of infusing mugwort plant/herb with alcohol or infusing alcohol with a mugwort plant/herb includes the following:
1) cutting a fully grown, ripe mugwort plant in half.
2) inserting one or both halves of the cut mugwort plant into an alcohol (in some embodiments, the mugwort plant may be initially ground or mashed so that fluids from the mugwort plant separate from the corpus of the mugwort plant).
3) shaking the combination/resulting admixture ten times per hour, for two minutes each time, for five days.
4) adding nootropic herbs and roots to the admixture.
5) letting all ingredients soak (infuse) for one month.
6) filtering the admixture using cheesecloth.
7) distilling the admixture.
8) checking consistency and keep distilling until there is no settling or residue of any kind, i.e., there is a “clean” and uniform liquid, meaning when liquid is moved in container there is no residue left and there is no settling of any added ingredients.

By following the above-listed steps, a user can make mugwort-infused alcohol which delivers the full benefits of the herb along with enhancing the effects of the alcohol into which it is being infused, wherein the alcohol may be different types of liquor.

The logic between the components is as follows: mugwort has several effects and health benefits, including producing a feeling of reduced stress and relaxation. Alcohol, in addition to these same effects, has other effects which enhance the feelings of reduced stress and relaxation, such as reducing inhibitions, increasing blood flow to the skin to create a warm and cocoon like feeling and dilating the blood vessels and capillaries. Put simply, alcohol causes blood vessels to expand, which reduces the fluid pressure in your circulatory system. Alcohol dilates (expands) blood vessels, which lowers your blood pressure. This also means that blood is sent directly to your brain, making you feel more relaxed. Because alcohol relaxes muscles all over the body, it causes the pupils to dilate as the muscles in the iris expand. Therefore, when another substance is added which promotes a feeling of relaxation, mood enhancement while at the same time improving cognition and consciousness, it not only enhances the effects of alcohol but transforms it by delivering its own range of effects and benefits. Therefore, you experience the best of both substances in a truly unique (and currently non-existent) form and way. This is unique and does not exist and therefore is protected.

The present invention can be improved upon by adding other substances, herbs, etc. to enhance the effects of not only the alcohol even further but the mugwort as well. Therefore, anything that adds, including but not limited to, any other herb, substance and/or chemical along with mugwort to be infused into alcohol is protected and contemplated herein. But one can go further and apply mugwort infusion to all kinds of food. Mugwort infused food can provide the full benefits and effects of mugwort along with full effects and benefits of the foods into which it is infused. Mugwort can also be used and delivered in different forms such as being smoked and/or vaporized. One can make mugwort and tobacco mixtures to be smoked and/or vaporized. One can infuse mugwort with other liquids, herbs, substances and/or chemicals to then be smoked and/or vaporized. Mugwort can also be smoked on its own, either by taking it and smoking it like a traditional plant like tobacco or transforming it into a liquid and then vaporizing it to be inhaled. One could also make pills of substances infused with Mugwort. One can also make Mugwort infused and combination products for living things outside of human beings, such as animals, plants, viruses, bacteria, cancer cells, etc.

Therefore, anything that infuses Mugwort into any kind of food and/or consumable product is contemplated by the present invention. Anything that alters and delivers mugwort in different forms, such being smoked by means of traditional substance combustion (burning the plant itself) and/or, including but not limited, transformed into an oil, vape juice, etc. to be vaporized or in any other way, shape and/or form to be able to be inhaled is contemplated by the present invention.

Mugwort and any other herb, substance, chemical and/or combination of substances to be delivered in any way, shape and/or form, including but not limited to, as an oil, vape juice, liquid to be vaporized, inhaled, etc. is protected. Anything which combines Mugwort with any other herb, substance and/or chemical in any way, shape and/or form into a pill or capsule is protected. Anything which combines mugwort with any other herb, substance and/or chemical in any way, shape and/or form for use in any living beings outside of humans, including but not limited to, animals, plants, viruses, bacteria, cancer cells, etc. is contemplated by the present invention.

Anything that infuses mugwort into any kind of alcohol is protected. Anything that infuses mugwort and any other herb, substance and/or chemical with any other combination, including but not limited to, any herb, substance and/or chemical with alcohol is contemplated by the present invention. Anything that infuses Mugwort and any other herb, substance and/or chemical with any other combination, including but not limited to, any herb, substance and/or chemical is protected.

Also, the present invention contemplates utilization in producing beneficial products for Healthcare industry, the Food and Beverage Industries, Smokeable Products, Vaporizing Products, Animal Care Products, Animal Feed Products, Agricultural Products (including but not limited to growth enhancers, fertilizers, etc.), Fast Food Restaurants, Chains and Franchises, Scientific Research Projects, Globally linked Research and Development, Textile Industry, Space Exploration and Colonization, Aerospace, Law Enforcement, Fire Dept, Emergency Services, Military, Intelligence Agencies, Judicial System Any Industry, Field and/or anything with employees (both human and non-human).

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A method of making mugwort infused alcohol comprises:
providing a mugwort herb;
providing an alcohol;
experimenting with at least one infusing technique comprising a soaking technique, a steeping technique, and a mixing technique of the mugwort herb into the alcohol;
developing timelines for each of the at least one infusing techniques; and
testing an admixture resulting from the at least one infusing techniques for each technique's efficacy on one or more effects of the mugwort herb and the alcohol.
